(19) United States
(12) Patent Application Publication
(10) Pub. No.: US 2013/0251022 A1
(43) Pub. Date: Sep. 26, 2013

(54) SIGNALING OF END OF SLICES

(71) Applicants: Rickard Sjöberg, Stockholm (SE); Per Wennersten, Arsta (SE)

(72) Inventors: Rickard Sjöberg, Stockholm (SE); Per Wennersten, Arsta (SE)

(73) Assignee: TELEFONAKTIEBOLAGET L M ERICSSON (PUBL), Stockholm (SE)

(21) Appl. No.: 13/500,014

(22) PCT Filed: Mar. 21, 2012
(86) PCT No.: PCT/SE12/50308

§ 371 Date: Apr. 3, 2012

(51) Int. Cl. H04N 7/26

(52) U.S. Cl. 375/240.01; 375/E07.2

(57) ABSTRACT

A slice granularity representing a hierarchical level for slice boundary alignment in a picture (1) comprising at least one slice (10, 12) of coding units (20-56) is used together with coordinates of the coding units (20-56) in a slice (10, 12) to determine those coding units (30, 46A, 46B, 36) that potentially could constitute an end of a slice (10, 12). Each coding unit (30, 46A, 46B) except one of the determined coding units (30, 46A, 46B, 36) is assigned an end-of-slice flag with a first value, while the one determined coding unit (36) gets an end-of-slice flag with a second value. The end-of-slice flags are used during decoding for identifying the end of a slice (10, 12). The embodiments provide an efficient end-of-slice flag signaling by merely assigning such flags to some of the coding units (30, 46A, 46B, 36) in the picture (1), while other coding units need no associated flag.

### TECHNICAL FIELD

The present embodiments generally relate to processing of pictures or video frames, and in particular to the encoding and decoding of such pictures or video frame and signaling end of slices in such pictures or video frames.

### BACKGROUND

H.264, also referred to as MPEG-4 (Motion Picture Expert Group) AVC (Advanced Video Coding), is to the state of the art video coding standard. It is a hybrid codec which takes advantages of eliminating redundancy between frames and within one frame. The output of the encoding process is VCL (Video Coding Layer) data which is further encapsulated into NAL (Network Abstraction Layer) units prior to transmission or storage.

High Efficiency Video Coding (HEVC) is a new video coding standard currently being developed in Joint Collaborative Team-Video Coding (JCT-VC). JCT-VC is a collaborative project between MPEG and ITU-T (International Telecommunication Union-Telecom). Currently, an HEVC Working Draft (WD) is defined and is considerably more efficient than H.264/AVC.

As video resolutions have increased, it has been noticed that large macroblocks can provide good video coding benefits. Traditionally macroblocks are in the order of 16×16 pixels in H.264, but it has been shown that macroblocks of up to 128×128 pixels can provide improved coding efficiency.

To enable both large macroblocks, and the coding of small detailed areas in the same picture, hierarchical block coding has been proposed and is used in the HEVC WD.

Large macroblocks, also referred to as largest coding units (LCUs) in the HEVC WD, are scanned left to right in the same way as macroblocks in H.264. Each LCU may be split, and the resulting blocks may be split again hierarchically in a quad-tree fashion. The resulting blocks after quad-tree splitting are called coding units (CU). The LCU is also a CU. There is also a smallest size defined, these blocks are called smallest coding unit (SCU). No SCU can be split to a smaller size. The LCU and SCU sizes are typically sent in a parameter set that is associated with the bitstream.

Generally, each picture is divided into one or more slices, where each slice is an independently decodable piece of the picture. In other words, if one slice is lost, the other slices of that picture are still decodable.

In H.264/AVC, a slice boundary or border may occur between any two macroblocks. In the HEVC WD, a slice boundary may occur between any two LCUs.

When using fine granularity slices in HEVC, it has been proposed to enable slice boundaries to occur further down in the CU hierarchy. A SliceGranularity codeword is sent to indicate how deep down in the hierarchy slices may start and end. For instance, if the LCU is 64×64 pixels, a SliceGranularity of 0 means that slices may only end after 64×64 blocks, a SliceGranularity of 1 means that slices may end not only after 64×64 blocks, but additionally also after 32×32 blocks, and a SliceGranularity of 2 means that they can also additionally end after 16×16 blocks.

When decoding a bitstream, the decoder needs to know when a slice ends. When not using fine granularity slices, this is done by sending an end-of-slice flag after each encoded LCU. When using fine granularity slices, signaling end-of-slice has been done after each encoded CU block, regardless of size. This prior art technique is inefficient, causing a significant amount of overhead in particular in connection with fine granularity slices.

Document JCTVC-D383 titled Simplification of end-of-slice coding for arithmetic coding by Frank Bossen at the ITU-T SG16 WP3 and ISO/IEC JTC1/SC29/WG11 meeting in Daegu, 20-28 January 2011 and document JCTVC-E042 titled Unified end-of-slice detection for LCEC and CABAC by Chih-Wi Hsu et al. at the ITU-T SG16 WP3 and ISO/IEC JTC1/SC29/WG11 meeting in Geneva, 16-23 March 2011 have made proposals to have the decoder detect the end of a slice by looking at what is left in the bitstream rather than sending an explicit flag. These proposals rely heavily on the exact way in which the bitstream is terminated.

There is a need for an efficient way of signaling end of slices in connection with video coding and/or decoding.

### SUMMARY

It is a general objective to provide an efficient way of signaling end of slices in connection with video coding and/or decoding.

This and other objectives are met by embodiments disclosed herein.

An aspect of the embodiments relates to a method of encoding a picture comprising at least one slice of coding units each having a respective size ranging from a size of a largest coding unit (LCU) to a size of a smallest coding unit (SCU). The method comprises providing, for at least one slice of the picture, a slice granularity representing a hierarchical level for slice granularity alignment. The hierarchical level defines a size of a smallest possible coding unit at which a slice start and a slice end in the picture can be aligned. Coding units that potentially could constitute an end of the slice is determined for the at least one slice and based on coordinates of the coding units in the slice and the slice granularity. The method further comprises assigning an end-of-slice flag having a first value to each coding unit that potentially could constitute the end of the slice except one coding unit. This one coding unit is instead assigned an end-of-slice flag having a second, different value.

Another aspect of the embodiments defines an encoder configured to encode a picture comprising at least one slice of coding units each having a respective size ranging from a size of an LCU to a size of an SCU. The encoder comprises a slice granularity provider configured to provide a slice granularity representing a hierarchical level for slice boundary alignment for at least one slice of the picture. The hierarchical level defines a size of a smallest possible coding unit at which a slice start and a slice end in the picture can be aligned. A coding unit determiner is configured to determine coding units that potentially could constitute an end of the slice for at least one slice and based on coordinates of the coding units in the slice and based on the slice granularity. The encoder comprises a flag assigner configured to assign, to each coding unit that potentially could constitute the end of the slice except one coding unit, an end-of-slice flag having a first value. The flag assigner is further configured to assign an end-of-slice flag having a second, different value to the one coding unit that was not assigned an end-of-slice flag with the first value.

A further aspect of the embodiments relates to a method of decoding a bitstream as an encoded representation of a picture comprising at least one slice of coding units each having a respective size ranging from a size of an LCU to a size of an SCU. The method comprises providing, for at least one slice of the picture, a slice granularity representing a hierarchical level for slice boundary alignment. The hierarchical level defines a size of a smallest possible coding unit at which a slice start and a slice end in the picture can be aligned. The method also comprises determining, for at least one slice and based on coordinates of the coding units in the slice and the provided slice granularity, coding units that potentially could constitute an end of the slice. An end-of-slice flag associated with a coding unit selected among the determined coding units that potentially could constitute the end of the slice is parsed in the bitstream. This parsed end-of-slice flag is then used to determine whether an end of the slice has been identified.

Yet another aspect of the embodiments defines a decoder configured to decode a bitstream as an encoded representation of a picture comprising at least one slice of coding units each having a respective size ranging from a size of an LCU to a size of an SCU. The decoder comprises a slice granularity provider configured to provide, for at least one slice of the picture, a slice granularity representing a hierarchical level for slice boundary alignment. The hierarchical level defines a size of a smallest possible coding unit at which a slice start and a slice end in the picture can be aligned. A coding unit determiner is configured to determine, for the at least one slice and based on coordinates of the coding units in the slice and based on the slice granularity, coding units that potentially could constitute an end of the slice. The decoder also comprises a bitstream parser configured to parse, in the bitstream, an end-of-slice flag associated with a coding unit selected among the coding units that potentially could constitute the end of the slice. A slice end determiner determines whether an end of the slice has been identified based on the end-of-slice flag.

The embodiments therefore provide an explicit signaling of end-of-slice flags but only for those coding units where slices may actually end, as defined based on the slice granularity parameter. This implies that fewer bits need to be sent, thereby increasing the compression ratio, as compared to assigning respective end-of-slice flags to all coding units in a picture.

### BRIEF DESCRIPTION OF THE DRAWINGS

The invention, together with further objects and advantages thereof, may best be understood by making reference to the following description taken together with the accompanying drawings, in which:

FIG. 1 is a flow diagram of a method of encoding a picture according to an embodiment;

FIG. 2 is a schematic example of a picture with slices of largest coding units and an example of a hierarchical split largest coding unit;

FIG. 3 is an example of a scan order inside a largest coding unit;

FIG. 4 schematically illustrates where slices may end: an end-of-slice flag will be signaled after the white coding units but not after striped coding units;

FIG. 5 illustrates slice-end signaling in a largest coding unit which contains a picture boundary: an end-of-slice flag is signaled after white coding units inside the picture but not after striped coding units;

FIG. 6 is a flow diagram illustrating an additional step of the method in FIG. 1;

FIG. 7 illustrates a bitstream as an encoded representation of a picture according to an embodiment;

FIG. 8 is a flow diagram illustrating a method of decoding a bitstream as an encoded representation of a picture according to an embodiment;

FIG. 9 is a flow diagram illustrating an embodiment of the slice end determining step in FIG. 8;

FIG. 10 is a schematic block diagram of an encoder according to an embodiment;

FIG. 11 is a schematic block diagram of a decoder according to an embodiment; and

FIG. 12 is a schematic block diagram of a media terminal according to an embodiment.

### DETAILED DESCRIPTION

Throughout the drawings, the same reference numbers are used for similar or corresponding elements.

The embodiments generally relate to the management of slices within pictures or video frames. In more detail, the embodiments provide an explicit end-of-slice signaling that can be performed in an efficient way that reduces the overhead and the amount of data that needs to be signaled from an encoder to a decoder.

The embodiments are applicable to any picture or video frame coding and decoding in which a picture or video frame, for instance of a video stream, can comprise at least one slice and where the end of the slices need to be signaled to the decoder. The embodiments are in particular applicable to such coding and decoding schemes utilizing a hierarchical splitting of blocks of pixels into smaller blocks of pixels. The embodiments are therefore well suited to be used in connection with High Efficiency Video Coding (HEVC) but are not limited thereto.

FIG. 2 schematically illustrates the concept of hierarchical coding and decoding, such as employed in HEVC.

A picture 1, such as of a video frame in a video stream, can be divided into a number of largest coding units (LCUs) 20. The LCU 20 is the largest possible block of pixels that can be handled during encoding and decoding, and can be processed, for instance, according to the well known intra or inter encoding/decoding modes. The LCU 20 can in turn be hierarchically split into a number of smaller, in terms of number of pixels, blocks of pixels, typically denoted coding units (CUs) 30, 32, 34, 36. These CUs 30, 32, 34, 36 may in turn be split further into even smaller blocks 40, 42, 44, 46 of pixels in a hierarchical manner down to a smallest possible block of pixels, denoted smallest coding unit (SCU).

FIG. 3 illustrates an example of such hierarchical splitting of coding units and the processing of the coding units in a scan order as indicated by the arrow. For instance, assume that the LCU 20 of FIG. 3 has a size of 128×128 pixels and with a SCU 50, 52, 54, 56 of 16×16 pixels. A slice header could then include the following code in a bitstream:

```
slice_header_syntax( )
split_coding_unit_flag=1  // split LCU 20 of 128×128 pixels into four CUs 30, 32, 34, 36 of 64×64
                        pixels
split_coding_unit_flag=1  // split first CU 30 of 64×64 pixels into four CUs of 32×32 pixels
split_coding_unit_flag=0  // code for first CU of 32×32 pixels
split_coding_unit_flag=0  // code for second CU of 32×32 pixels
split_coding_unit_flag=0  // code for third CU of 32×32 pixels
split_coding_unit_flag=0  // code for fourth CU of 32×32 pixels
split_coding_unit_flag=1  // split second CU 32 of 64×64 pixels into four CUs 40, 42, 44, 46 of 32×32
                        pixels
split_coding_unit_flag=1  // split first CU 40 of 32×32 pixels into four SCUs 50, 52, 54, 56 of 16×16
                        pixels, no further split flag needed since 16×16 is smallest block size, code
                        for four SCUs 50, 52, 54, 56 of 16×16 pixels
split_coding_unit_flag=1  // split second CU 42 of 32×32 pixels into four SCUs of 16×16 pixels, no
                        further split flag needed, code for four SCUs of 16×16 pixels
split_coding_unit_flag=1  // split third CU 44 of 32×32 pixels into four SCUs of 16×16 pixels, no further
                        split flag needed, code for four SCUs of 16×16 pixels
split_coding_unit_flag=1  // split fourth CU 46 of 32×32 pixels into four SCUs of 16×16 pixels, no
                        further split flag needed, code for four SCUs of 16×16 pixels
split_coding_unit_flag=1 // split third CU 34 of 64×64 pixels into four CUs of 32×32 pixels
split_coding_unit_flag=0  // code for first CU of 32×32 pixels
split_coding_unit_flag=0  // code for second CU of 32×32 pixels
split_coding_unit_flag=0  // code for third CU of 32×32 pixels
split_coding_unit_flag=0  // code for fourth CU of 32×32 pixels
split_coding_unit_flag=0  // code for the fourth CU 36 of 64×64 pixels
```

In the code presented above slice_header_syntax( ) is the slice header and the split coding unit flag indicates to the decoder whether the current CU should be split further or not. Note that if the current coding unit is an SCU then no split_coding_unit_flag is sent since it is not allowed to be split further.

According to a recent proposal for HEVC the start and end of slices 10, 12 in a picture 1 can generally be aligned with the border between any adjacent coding units 20-46 in the picture 1 from the SCU level up to the LCU level. Hence, it is then possible that the end of a slice will be positioned inside an LCU with the last coding unit of the current slice and the first coding unit of the next slice in the same LCU.

A slice granularity is then used to represent a hierarchical level for slice boundary alignment. The hierarchical level defines a size of a smallest possible coding unit at which a slice start and a slice end in the picture can be aligned. Thus, this slice granularity indicates how deep down in the hierarchy slices may start and end.

For instance, if the LCU size is 64×64 pixels a slice granularity of 0 could mean that slices may only end after 64×64 coding units, i.e. LCUs. A slice granularity of 1 could mean that slices may end not only after 64×64 coding units but additionally also after 32×32 coding units. Correspondingly, a slice granularity of 2 could mean that they can also additionally end after 16×16 coding units, i.e. in addition to after coding units of 64×64 pixels or of 32×32 pixels.

The embodiments provide an efficient signaling of end of slices that can be applied to such hierarchical splitting of coding units and the usage of slice granularity for defining at what hierarchical level slice boundary alignment is possible within a picture or a video frame. This is achieved by signaling an explicit end-of-slice flag but only where slices may actually end, depending on the slice granularity parameter. Hence, such end-of-slice flags need not be used in connection with each coding unit as suggested in the prior art but merely after those coding units at which the end of slice may actually occur as defined by the slice granularity for the current slice and picture. The embodiments thereby significantly reduce the number of end-of-slice flags that need to transmitted from the encoder to the decoder and thereby reduce the overhead of the bitstream representing the encoded picture.

According to the embodiments, “slice” is employed to denote an independently codable and decodable portion of a picture or video frame. A picture can thereby be composed of a single slice or multiple, i.e. at least two, slices.

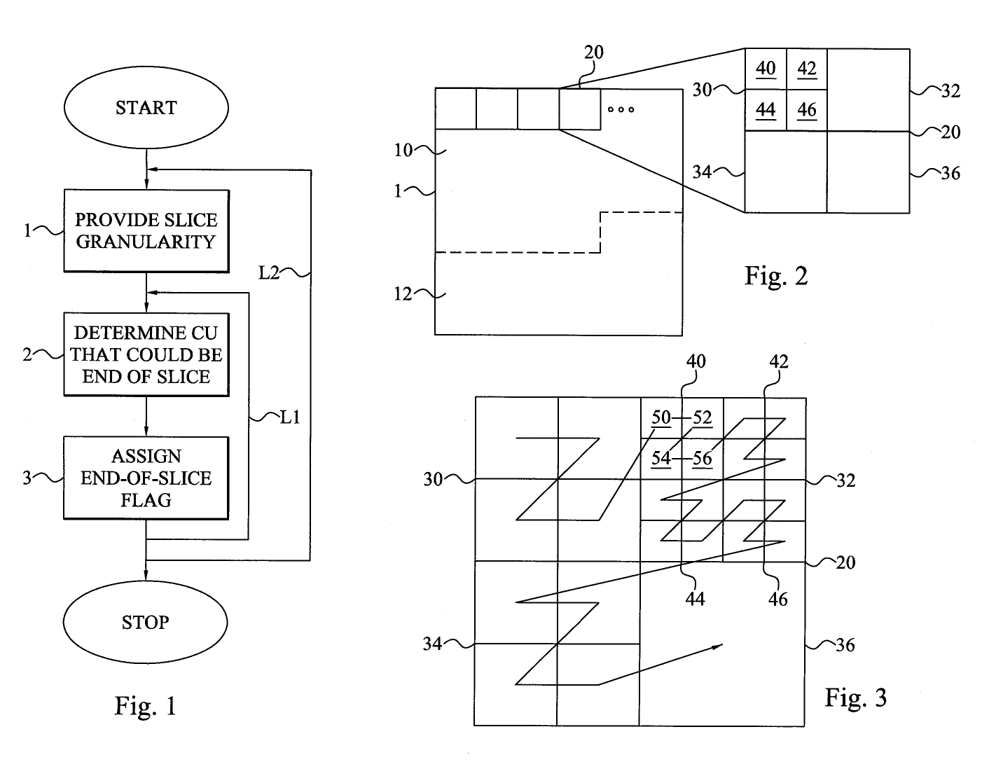

FIG. 1 is a flow diagram of a method of encoding a picture comprising at least one slice of coding units. Such coding units can have a respective size ranging from a size of an LCU down to a size of an SCU. The method starts in step S1 where a slice granularity is provided for at least one slice in the picture. As discussed in the foregoing, this slice granularity represents a hierarchical level for slice boundary alignments, where the hierarchical level defines a size of a smallest possible coding unit at which a slice start and a slice end in the picture can be aligned.

A next step S2 determines the coding units of the at least one slice that potentially could constitute an end of the slice. This step S2 is performed based on the respective coordinates of the coding units in the slice or in the picture and the slice granularity provided in step S1.

The following step S3 assigns an end-of-slice flag to the coding units determined in step S2. This end-of-slice flag has a first value if the relevant coding unit is not the last coding unit of the current slice and a second, different value if the coding unit is indeed the last coding unit of the current slice. The result of step S3 is that each coding unit determined in step S2 is associated with a respective end-of-slice flag. One of these determined coding unit has the second value for its end-of-slice flag, such as 1_{bin}, whereas the other coding units determined in step S2 for the current slice instead have the first value for the end-of-slice flag, such as 0_{bin}.

The embodiments therefore identify and determine, based on the slice granularity provided for the current slice and the respective coordinates of the coding units in the slice, which coding units that potentially could constitute an end of the slice. Only these coding units need to carry an end-of-slice flag. The remaining coding units of the slice, i.e. those that are not able to constitute an end of the slice as determined based on the slice granularity and their coordinates, will not have any associated end-of-slice flag. This means that for most slices the vast majority of the coding units will not carry any end-of-slice flags, which thereby reduces the amount of data that needs to be communicated for the current slice.

The determination of coding units in step S2 and the assignment of end-of-slice flags in step S3 are preferably performed for each slice of the picture, which is schematically indicated by the line L1. In such an approach a single slice granularity is preferably provided for all the slices in the picture. In such a case, step S1 involves providing the slice granularity for multiple slices of the picture. These slices then use the same slice granularity. This is typically preferred but the embodiments are not limited thereto. In clear contrast, each slice of a picture could have a respective associated slice granularity. Step S1 is then performed once for each slice in the picture.

The method of steps S1 to S3 indicted in FIG. 1 is preferably performed multiple times for a stream of pictures or video frames, i.e. a video stream, which is schematically indicated by the line L2 in FIG. 1. In such a case, the provision of slice granularity in step S1 could be performed once per picture or indeed once per slice in the pictures. Alternatively, one and the same slice granularity could be used for multiple pictures in the video stream. In such a case, step S1 is preferably performed once for multiple pictures. A new provision of slice granularity is performed if the slice granularity is to be changed for one or more pictures in the video stream.

The provision of slice granularity in step S1 could be performed according to various embodiments. In an approach one and the same slice granularity is to be used for multiple slices or pictures and this single slice granularity could, for instance, be fixed or pre-defined for this picture or these pictures. The provision of step S1 then involves retrieving information of this particular (fixed or pre-defined) slice granularity for the picture(s). In an alternative approach, the slice granularity to use for a picture or multiple pictures is determined during the encoding process. Hence, in such a case step S1 preferably involves determining a slice granularity for at least one slice of a picture to be encoded.

The slice granularity is preferably determined to achieve as efficient coding of the picture as possible. Thus, increasing the slice granularity to enable slice boundary alignment deeper down in the hierarchy increases the number of possible slice start and end positions within a picture. This furthermore increases lengths of slice addresses in terms of the number of bits, thereby increasing the overhead of the encoded picture data. However, having a larger slice granularity could be beneficial in terms of achieving close to a target slice size, such as fitting the encoded slice data in a single IP data packet.

In an embodiment step S2 of FIG. 1 involves determining, for at least one slice in the picture and based on coordinates of the coding units in the slice and the slice granularity provided in step S1, those coding units that potentially could constitute the end of the slice to be any coding unit in the slice that have a size equal to or larger than a size defined by the slice granularity. Thus, the slice granularity thereby defines a size of a smallest possible coding unit for slice border alignment. Step S2 then involves determining those coding units that have a size equal to or larger than size of the smallest possible coding unit as defined by the slice granularity.

For instance, assume a LCU size of 64×64 pixels, then a slice granularity of 0 indicates that the smallest possible coding unit at which slice boundary alignment can occur is 64×64 pixels. Correspondingly, a slice granularity of 1 implies that those coding units that have a size of 64×64 pixels or 32×32 pixels could constitute the end of the slice. However, coding units that are smaller than 32×32 pixels, such as 16×16 pixels can then generally not constitute an end of the slice.

In a particular embodiment, step S2 determines those coding units in the slice that have a size equal to or larger than the size defined by the slice granularity and any coding unit constituting a last coding unit in a coding unit having a size equal to or larger than the size defined by the slice granularity. One can then think of this as a picture grid with a grid size that is equal to the slice granularity. Then end-of-slice flags are only sent after those coding units that after being decoded leave no partially decoded slice granularity grid blocks.

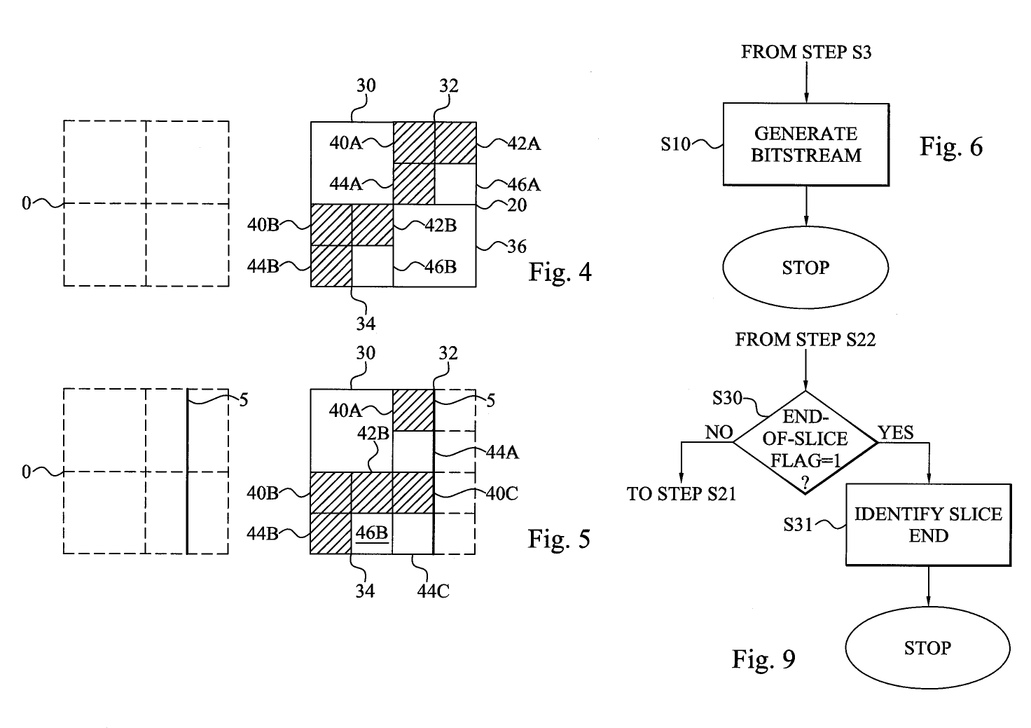

FIG. 4 schematically illustrates this concept. The left part of FIG. 4 indicates the above-mentioned granularity grid for a LCU 20. Thus, if the LCU 20 has a size of, for instance, 64×64 pixels the slice granularity has in the present case a value of 1 indicating a smallest or minimum size at which slices may end is 32×32 pixels.

The right part of FIG. 4 indicates after which coding units an end-of-slice flag will be signaled in white and those coding units (hatched) for which no end-of-slice flags need to be signaled. As stated above step S2 could determine those coding units that have a size equal to or larger than the size defined by the slice granularity. This corresponds to coding units 30, 32, 34, 36 of FIG. 4 and of course the LCU 20. The end of the LCU 20 is in fact also the end of the coding unit 36. Hence, only a single end-of-slice flag is needed for this position. Correspondingly, coding units 32, 34 are hierarchically split into four respective smaller coding units 40A, 42A, 44A, 46A, 40B, 42B, 44B, 46B. Coding unit 46A is the last coding unit of coding unit 32 and therefore the end of coding unit 46A coincide with the end of coding unit 32. A single end-of-slice flag is thereby sufficient for indicating this position as a potential end of the slice. Correspondingly, the end of coding unit 46B and coding unit 34 coincide and thereby only requires a single end-of-slice flag.

Hence, according to an embodiment, four end-of-slice flags are signaled for the LCU 20 shown in FIG. 4, which should be compared to ten end-of-slice flags if each coding unit would have been associated with a respective end-of-slice flag as in the prior art.

If the size of the smallest possible coding unit defined by the slice granularity is N×N pixels a particular embodiment of step S2 in FIG. 1 determines the coding units that potentially could constitute the end of the slice to be the coding units in the slice for which (x+1) is even divisible by N or (x+1) is equal to the width of the picture and (y+1) is even divisible by N or (y+1) is equal to the height of the picture. In such a case, (x, y) represents the coordinates of the bottom-right pixel in the coding unit in a coordinate system with origin (0, 0) at the top-left corner of the picture. Thus if both the condition with regard to the x coordinate and the condition with regard to the y coordinate are fulfilled an end-of-slice flag needs to be signaled for the coding unit. Otherwise no end-of-slice flag is assigned to the coding unit.

If the slice granularity indicates, as mentioned in the previous examples, a smallest possible coding unit of 32×32 pixels then step S2 determines those coding units for which (x+1)=m×32 and (y+1)=n×32, where m, n are positive integers. Thus, any coding units having coordinates (31, 31); (31, 63); (63, 31) and (63, 63) for their respective last (bottom-right) pixel are determined to be potential ends of the slice. This corresponds to coding units 30, 46A (or 32), 46B (or 34) and 36 (or 20) in FIG. 4. If the picture is larger than what is shown in FIG. 4 also other pixel coordinates are tested, i.e. (31, 95); (31, 127); . . . ; (63, 95); (63, 127); . . . ; (95, 31); (95, 63); . . . ; and so on.

Each coding unit that is determined to potentially constitute the end of the slice is preferably only assigned a single end-of-slice flag. For instance, the end position of the coding unit that is in the lower right corner of coding unit 46 in FIG. 3 is in fact also the end position of the coding unit 46 and the coding unit 32. Thus, this end position is in fact shared by three coding units in this example. However, it is sufficient if a single end-of-slice flag is assigned to this end position to indicate whether it constitutes an end of a slice or not.

FIG. 5 illustrates the corresponding granularity grid and split LCU but with a picture boundary 5 occurring inside the LCU 20. The conditions mentioned above indicated that i) (x+1) is evenly divisible by N or (x+1) is equal to a width of the picture and ii) (y+1) is evenly divisible by Nor (y+1) is equal to a height of the picture.

In FIG. 5 the coding unit 30 and 46B (or 34) has (x+1) evenly divisible by N and (y+1) evenly divisible by N. Coding units 44A, 46A have (x+1) equal to the width of the picture and (y+1) evenly divisible by N. Hence, these four coding units 30, 44A, 46B, 44C are assigned a respective end-of-slice flag whereas remaining coding units 40A, 40B, 42B, 44B, 40C are not assigned any end-of-slice flag.

If coding units can have a non-quadratic shape, i.e. rectangular, and the smallest possible coding unit as defined by the slice granularity has a size of M×N pixels then the two conditions presented above are preferably i) (x+1) is evenly divisible by M or (x+1) is equal to a width of the picture and ii) (y+1) is evenly divisible by N or (y+1) is equal to a height of the picture.

FIG. 6 is a flow diagram illustrating an additional step of the method in FIG. 1. The method continues from step S3 of FIG. 1. A next step S10 generates a bitstream as encoded representation of the picture. The bitstream then comprises a respective coded representation of pixel values for each coding unit in each slice of the picture. Furthermore, the bitstream comprises a respective end-of-slice flag for each coding unit determined in step S2 of FIG. 1 to constitute a potential end of the a slice and which are assigned an end-of-slice flag in step S3.

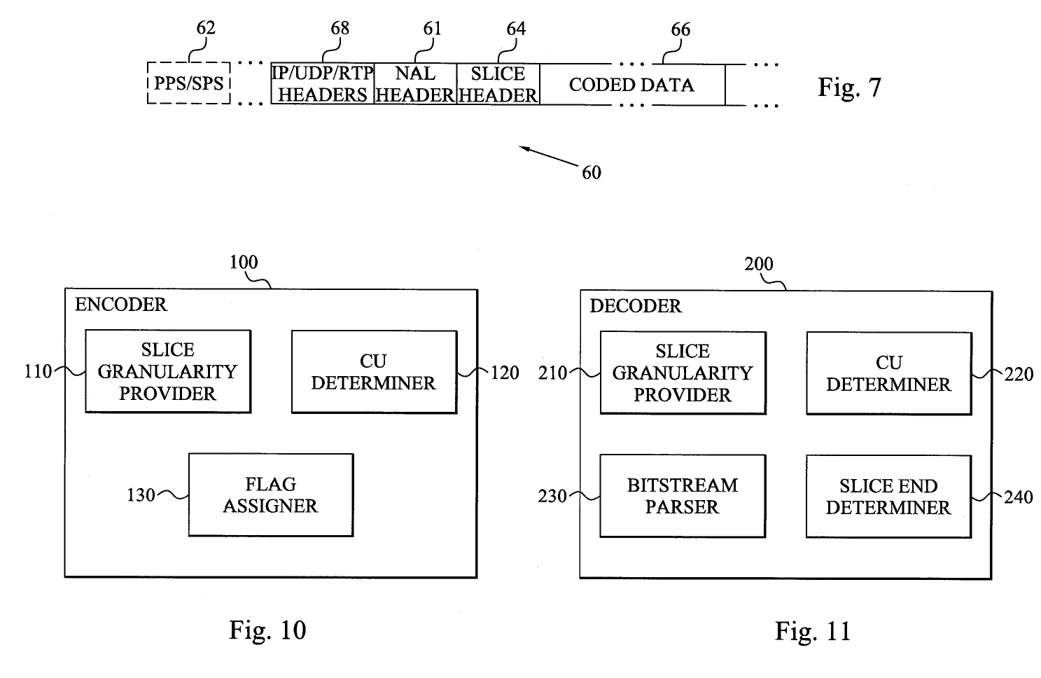

FIG. 7 is a schematic illustration of such a bitstream 60. The encoding process outputs so-called Network Adaptation Layer (NAL) units. The first byte of the NAL unit is a header 61 that contains an indication of the type of data in the NAL unit. The remaining bytes of the NAL unit contain payload data in the form of slice headers 64 and encoded data 66 of the picture.

The NAL unit may then be added with Real-time Transport Protocol (RTP), User Datagram Protocol (UDP) and Internet Protocol (IP) headers 68 to form a data packet that can be transmitted as part of the bitstream from the encoder to a decoder. This form of packetization of NAL units merely constitute an example in connection with video transport. Other approaches of handling NAL units, such as file format, MPEG-2 transport streams, MPEG-2 program streams, etc. are possible.

The slice header 64 of a slice can refer to a picture parameter set (PPS) 62 that contains information which apply to the decoding of one or more individual pictures. The PPS 62 may in turn refer to a sequence parameter set (SPS) 62 that contains information which apply a series of consecutive coded video pictures.

In a particular embodiment the slice granularity provided in step S1 is preferably included in the bitstream 60 to thereby be signaled to the decoder. In such a case, the slice granularity or information enabling calculation of the slice granularity could be included, for instance, in the slice header 64. In an alternative approach, the slice granularity or the information enabling calculation thereof is included in a parameter set included in or otherwise associated to the bitstream 60, such as in the SPS 62 or the PPS 62. If the same slice granularity is to be used for multiple pictures, signaling in the SPS 62 is generally preferred. It is also possible to use a pre-defined a slice granularity for a given profile that defines the codec mode. In such a case, the slice granularity could be derived from the profile_idc parameter in the SPS 62. The encoded representation of a slice then preferably comprises an indication or pointer, such as in the slice header 64, allowing identification of which SPS 62 or PPS 62 to use for the current slice and therefore which slice granularity to use. The SPS or PPS 62 can be included in the bitstream or be signaled out of band.

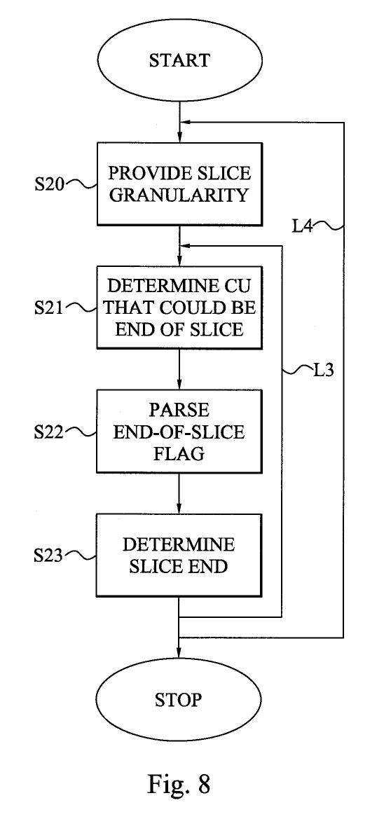

FIG. 8 is a flow diagram illustrating a method of decoding a bitstream as encoded representation of a picture comprising at least one slice of coding units, where each coding unit has a respective size ranging from an LCU to an SCU. The method starts in step S20 where a slice granularity is provided for at least one slice in a picture. The slice granularity represents, as previously disclosed herein, a hierarchical level for slice boundary alignment and defines a size of a smallest possible coding unit at which a start and an end of a slice in the picture can be aligned.

A next step S21 determines the coding units in the slice that potentially could constitute an end of the slice. This determination is performed for the at least one slice and based on the coordinates of the coding units in the slice. Once the coding units that potentially could constitute an end of the slice have been determined and identified in step S21, the method continues to step S22 which parses, in the bitstream, an end-of-slice flag associated with a coding unit selected among the coding units that potentially could constitute the end of the slice as determined in step S21. A next step S23 determines whether an end of the slice has been identified based on the end-of-slice flag parsed in step S22 and in particular based on the value of this end-of-slice flag.

Thus, the slice granularity associated with the current slice and preferably the current picture is used to determine those coding units that potentially could constitute the end of the slice. Only these coding units have associated end-of-slice flags, while remaining coding units of the slice do not carry any such end-of-slice flag in their encoded representation of the pixel data for the coding units.

Generally, the decoding of a picture is performed by processing the LCUs left to right and from top to bottom. The coding units in a LCU that is hierarchically split are then processed in a scan order, an example of which is illustrated in FIG. 3 in the form of the Morton or Z order. Once a coding unit that is determined in step S21 to be a potential end of a slice is reached the decoder parses the bitstream portion of this coding unit and reads the value of the end-of-slice flag associated with the coding unit. If the end-of-slice flag has a first value, the decoder concludes that the current coding unit does not constitute the last coding unit of the slice. The decoding process is therefore continued for the slice by continuing parsing and decoding the next coding unit in the bitstream and assigning it to the current slice. However, if the parsed end-of-slice flag instead has a second value, the decoder identifies that the current coding unit is the last coding unit of the slice and that the slice end has been reached. The decoder will then close the slice and decode a completely new slice next.

In an embodiment the determination of whether the end of the slice has been identified comprises determining that a current coding unit associated with the end-of-slice flag does not constitute a last coding unit of the slice if the end-of-slice flag has a first value. Correspondingly, the current coding unit associated with the end-of-slice flag is determined as constituting the last coding unit of the slice if the end-of-slice flag has a second, different value.

This is schematically illustrated in FIG. 9, which is a representation of a particular embodiment of the determining step S23 of FIG. 8. The method continues from step S22 of FIG. 8. A next step S30 investigates whether the end-of-slice flag has the second value, such as 1_{bin}. In such a case, the method continues to step S31 which identifies the current coding unit associated with the end-of-slice flag as the last coding unit of the slice. If the end-of-slice flag instead has the first value, such as 0_{bin}, the method continues to step S21 or step S22 of FIG. 8 by continuing the processing of coding units of the bitstream for the current slice.

In an embodiment, step S21 is performed once for a slice or picture and thereby identifies all the coding units in the slice or picture that could constitute a slice end. Then a loop formed by steps S22 and S23 is performed once for each such identified coding unit once the decoding process has reached the point where this particular coding unit is to the be decoded from the bitstream. In an alternative approach, step S21 is performed once for each coding unit as it is being decoded from the bitstream. Thus, the decoder then determines based on the slice granularity and the coordinates of the current coding unit in the slice or picture, whether the coding unit could potentially constitute an end of slice. If so the method continues to steps S22 and S23. Otherwise the method returns to step S21 once the current coding unit has been decoded to thereby process a next coding unit.

As mentioned in connection with FIG. 1, the slice granularity can be applied to one slice of a picture or preferably for multiple, such as all, slices of a picture. It is also possible that multiple pictures in the bitstream use the same slice granularity, which is schematically illustrated by the line L3. Hence, in such a case, step S20 only needs to be performed once per picture or once for multiple pictures. If the slice granularity is changed for a new picture, such as signaled in the bitstream or in a parameter set associated with the bitstream, step S20 is performed anew to provide the new or updated slice granularity, which is schematically indicated by the line L4.

The slice granularity could be signaled in or associated with the bitstream as discussed in the foregoing. In such a case, step S20 preferably involves retrieving the slice granularity from the bitstream or, for instance, from a parameter set, such as PPS or SPS, associated with the bitstream. Alternatively, the bitstream or the parameter set includes information that is retrieved therefrom. The slice granularity is then calculated or determined from this retrieved information.

A further approach is to use a fixed or pre-defined slice granularity that applies to all slices of all or at least a defined set of pictures in the bitstream. This pre-defined slice granularity is then known both at the encoder and decoder sides, thereby relaxing the need for signaling the slice granularity to the decoder. Step S20 then preferably involves providing this pre-defined slice granularity, such as from a memory available to the decoder.

Step S21 of FIG. 8 preferably involves, as step S2 of FIG. 1, determining the coding units in the slice that potentially could constitute the end of the slice to be any coding unit having a size equal to or larger than a size defined by the slice granularity, i.e. preferably the size of the previously mentioned smallest possible coding unit as defined by the slice granularity.

In a particular embodiment, step S21 determines the coding unit to be any coding unit in the slice having a size equal to or larger than the size defined by the slice granularity and any coding unit constituting a last coding unit hierarchically split from a coding unit having a size equal to or larger than the size defined by the slice granularity.

The coordinates of the coding units and the slice granularity are preferably used in step S21 to determine the coding units by imposing a number of conditions that need to be met. Thus, if the slice granularity defines the smallest possible coding unit to be of N×N pixels and (x, y) denotes the coordinates of a bottom-right pixel in a coding unit in a coordinate system with origin at a top-left corner of the picture then two conditions need to be met. The first condition regards the x coordinate and defines that (x+1) should be evenly divisible by N or (x+1) is equal to the width of the picture. The second condition regards the y coordinate and defines that (y+1) should be evenly divisible by N or (y+1) is equal to the height of the picture. If both the first and second conditions are met for a coding unit the coding unit is determined in step S21 to potentially constitute an end of the slice.

Compared to sending an end-of-slice flag after each coding unit, the described embodiments have the benefit of requiring fewer bits to be sent, thereby increasing the compression ratio. Compared to implicitly deriving the end-of-slice flag without explicit signaling, the embodiments place fewer requirements on the way a bitsteam is handled and received.

FIG. 10 is a schematic block diagram of an encoder 100 according to an embodiment. The encoder 100 comprises a slice granularity provider 110 configured to provide, for at least one slice of a picture, a slice granularity representing a hierarchical level for slice boundary alignment. This slice granularity is used by a coding unit determiner 120 together with coordinates of coding units in the slice for determining those coding units of the slice that potentially could constitute an end of the slice. A flag assigner 130 of the encoder 100 is configured to assign a respective end-of-slice flag to those coding units identified by the coding unit determiner 120. Thus, for a given slice the flag assigner 130 assigns a respective end-of-slice flag having a first value to each determined coding unit except one and assigns an end-of-slice flag having a second, different value to one of the determined coding units. This coding unit that gets an end-of-slice flag with the second value constitutes the last coding unit of the slice, whereas the other coding units with end-of-slice flags of the first value are not the last coding unit of the slice.

In an embodiment, the coding unit determiner 120 is configured to determine the coding units that potentially could constitute the end of the slice to be any coding unit in the slice having a size equal to or larger than a size defined by the slice granularity and optionally any coding unit constituting a last coding unit in a coding unit in the slice having a size equal to or larger than the size defined by the slice granularity.

The coding unit determiner 120 determines, in a particular embodiment, a coding unit to be a potential end of a slice if i) (x+1) is even divisible by N or (x+1) is equal to the width of the picture and ii) (y+1) is evenly divisible by N or (y+1) is equal to a height of the picture. (x, y) represents the coordinates of a bottom-right pixel in the coding unit in a coordinate system with origin at a top-left corner of the picture and the slice granularity defines a smallest possible coding unit for slice boundary alignment to have a size of N×N pixels.

The encoder 100 is configured to generate a bitstream as an encoded representation of a picture as previously discussed herein. The bitstream comprises, for each coding unit in each slice of the picture, a respective coded representation of the pixel values of the coding unit. In addition, each coding unit determined by the coding unit determiner 120 additionally comprises a respective end-of-slice flag.

The slice granularity provided by the slice granularity provider 110 and used by the coding unit determiner 120 could be signaled to the decoder, unless already known to the decoder. In such a case, the encoder 100 is preferably configured to include the slice granularity or information allowing the decoder to calculate the slice granularity in the bitstream or in a parameter set associated with the bitstream, such as transmitted out-of-band with regard to the bitstream that then carries an identifier or pointer to the relevant parameter set.

The slice granularity 110 preferably provides the slice granularity to apply to all slices of a picture. The coding unit determiner 120 then uses this slice granularity when determining potential slice ends for all the slices in the picture.

The encoder 100 could be implemented at least partly in software. In such an embodiment, the encoder 100 is implemented as a computer program product stored on a memory and loaded and run on a general purpose or specially adapted computer, processor or microprocessor, such as a central processing unit (CPU). The software includes computer program code elements or software code portions effectuating the operation of at least the slice granularity provider 110, the coding unit determiner 120 and the flag assigner 130. The program may be stored in whole or part, on or in one or more suitable volatile computer readable media or data storage means, such as RAM, or one or more non-volatile computer readable media or data storage means, such as magnetic disks, CD-ROMs, DVD disks, hard discs, in ROM or flash memory. The data storage means can be a local data storage means or is remotely provided, such as in a data server. The software may thus be loaded into the operating memory of a computer or equivalent processing system for execution by a processor. The computer/processor does not have to be dedicated to only execute the above-described functions but may also execute other software tasks. A non-limiting example of program code used to define the encoder 100 include single instruction multiple data (SIMD) code.

Alternatively the encoder 100 can be implemented in hardware. There are numerous variants of circuitry elements that can be used and combined to achieve the functions of the units 110-130 of the encoder 100. Such variants are encompassed by the embodiments. Particular examples of hardware implementation of the encoder 100 is implementation in digital signal processor (DSP) hardware and integrated circuit technology, including both general-purpose electronic circuitry and application-specific circuitry.

FIG. 11 is a schematic block diagram of a decoder 200 configured to decode a bitstream as an encoded representation of a picture comprising at least one slice of coding units. The decoder 210 comprises a slice granularity provider 210 configured to provide a slice granularity for at least one slice of a picture. The slice granularity provided by the slice granularity provider 210 is used by a coding unit determiner 220 to determine, based on coordinates of coding units in the slice, coding units that potentially could constitute an end of the slice. A bitstream parser 230 of the decoder 200 is configured to parse, in the bitstream, an end-of-slice flag associated with a coding unit selected among the coding units that potentially could constitute the end of the slice as determined by the coding unit determiner 220. The end-of-slice flag parsed and read by the bitstream parser 230 is used by a slice end determiner 240 to determine whether an end of the slice has been identified based on the end-of-slice flag and whether the current coding unit constitutes the last coding unit of the slice.

The slice granularity provider 210 is in an embodiment configured to retrieve the slice granularity from the bitstream itself, such as a slice header, PPS or SPS in the bitstream, or from a parameter set, such as PPS or SPS, that could be received by the decoder 200 separately from but associated with the bitstream. In another embodiment, the slice granularity provider 210 is configured to retrieve information from the bitstream or the associated parameter set and then processes this information for the purpose of calculating the slice granularity therefrom. In a further embodiment, the value of the slice granularity is already known to the decoder 200 and therefore is not necessarily received in or associated with the bitstream. The slice granularity provider 210 then preferably retrieves the slice granularity from a memory (not illustrated) accessible to the decoder 200.

In an embodiment, the coding unit determiner 220 is configured to determine the coding units that potentially could constitute the end of the slice to be any coding unit in the slice having a size equal to or larger than a size defined by the slice granularity and optionally any coding unit constituting a last coding unit in a coding unit in the slice having a size equal to or larger than the size defined by the slice granularity.

The coding unit determiner 220 determines, in a particular embodiment, a coding unit to be a potential end of a slice if i) (x+1) is even divisible by Nor (x+1) is equal to the width of the picture and ii) (y+1) is evenly divisible by N or (y+1) is equal to a height of the picture. (x, y) represents the coordinates of a bottom-right pixel in the coding unit in a coordinate system with origin at a top-left corner of the picture and the slice granularity defines a smallest possible coding unit for slice boundary alignment to have a size of N×N pixels.

The slice end determiner 240 is preferably configured to determine that a current coding unit associated with the end-of-slice flag parsed by the bitstream parser 230 does not constitute a last coding unit of the slice if the end-of-slice flag has a first value, such as 0_{bin}. Correspondingly, the slice end determiner 240 is preferably configured to determine that the current coding unit associated with the end-of-slice flag constitutes the last coding unit of the slice if the end-of-slice flag has a second, different value, such as 1_{bin}.

The decoder 200 could be implemented at least partly in software. In such an embodiment, the decoder 200 is implemented as a computer program product stored on a memory and loaded and run on a general purpose or specially adapted computer, processor or microprocessor, such as a central processing unit (CPU). The software includes computer program code elements or software code 30 portions effectuating the operation of at least the slice granularity provider 210, the coding unit determiner 220, the bitstream parser 230 and the slice end determiner 240. The program may be stored in whole or part, on or in one or more suitable volatile computer readable media or data storage means, such as RAM, or one or more non-volatile computer readable media or data storage means, such as magnetic disks, CD-ROMs, DVD disks, hard discs, in ROM or flash memory. The data storage means can be a local data storage means or is remotely provided, such as in a data server. The software may thus be loaded into the operating memory of a computer or equivalent processing system for execution by a processor. The computer/processor does not have to be dedicated to only execute the above-described functions but may also execute other software tasks. A non-limiting example of program code used to define the decoder 200 include single instruction multiple data (SIMD) code.

Alternatively the decoder 200 can be implemented in hardware. There are numerous variants of circuitry elements that can be used and combined to achieve the functions of the units 210-240 of the decoder 200. Such variants are encompassed by the embodiments. Particular examples of hardware implementation of the encoder 100 is implementation in digital signal processor (DSP) hardware and integrated circuit technology, including both general-purpose electronic circuitry and application-specific circuitry.

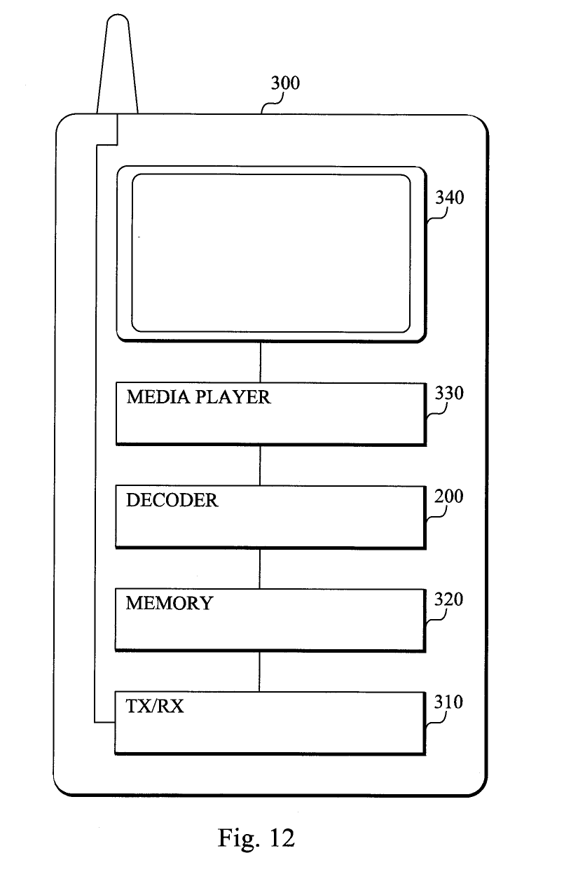

FIG. 12 is a schematic block diagram of a media terminal 300 housing a decoder 200 for decoding an encoded representation of a picture. The media terminal 300 can be any device having media decoding functions that operates on an encoded bit stream, such as a video stream of encoded video frames to thereby decode the video frames and make the video data available. Non-limiting examples of such devices include mobile telephones and other portable media players, computers, decoders, game consoles, etc. The media terminal 300 comprises a memory 320 configured to store an encoded representation of a picture, such as encoded video frames. The encoded representation can have been generated by the media terminal 300 itself. In such a case, the media terminal 300 preferably comprises a media engine or recorder together with a connected encoder, such as the encoder 100 illustrated in FIG. 10. Alternatively, the encoded representations are generated by some other device and wirelessly transmitted or transmitted by wire to the media terminal 300 in the form of a bitstream. The media terminal 300 then comprises a transceiver 310 (transmitter (TX) and receiver (RX)) or input and output port to achieve the data transfer.

The encoded representation is brought from the memory 320 to the decoder 200, such as the decoder illustrated in FIG. 11. The decoder 200 decodes the encoded representation into a decoded picture or as decoded video frames. The decoded data is provided to a media player 330 that is configured to render the decoded picture data or video frames into data that is displayable on a display or screen 340 of or connected to the media terminal 300.

In FIG. 12, the media terminal 300 has been illustrated as comprising both the decoder 200 and the media player 330. This should, however, merely be seen as an illustrative but non-limiting example of an implementation embodiment for the media terminal 300. Also distributed implementations are possible where the decoder 200 and the media player 330 are provided in two physically separated devices are possible and within the scope of media terminal 300 as used herein. The display 340 could also be provided as a separate device connected to the media terminal 300, where the actual data processing is taking place.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method of encoding a picture comprising at least one slice of coding units each having a respective size ranging from a size of a largest coding unit to a size of a smallest coding unit, comprising:
providing, for at least one slice of said picture, a slice granularity representing a hierarchical level for slice boundary alignment, said hierarchical level defining a size of a smallest possible coding unit at which a slice start and a slice end in said picture can be aligned;
determining, for said at least one slice and based on coordinates of said coding units in said slice and said slice granularity, coding units that potentially could constitute an end of said slice;
assigning, to each coding unit that potentially could constitute said end of said slice except one coding unit, an end-of-slice flag having a first value; and
assigning, to said one coding unit, an end-of-slice flag having a second, different value.

2. The method according to claim 1, wherein determining said coding units comprises determining, for said at least one slice and based on coordinates of said coding units in said slice and said slice granularity, said coding units that potentially could constitute said end of said slice to be any coding unit in said at least one slice having a size equal to or larger than a size defined by said slice granularity.

3. The method according to claim 2, wherein determining said coding units comprises determining, for said at least one slice and based on coordinates of said coding units in said slice and said slice granularity, said coding units that potentially could constitute said end of said slice to be any coding unit in said at least one slice having a size equal to or larger than said size defined by said slice granularity and any coding unit constituting a last coding unit in a coding unit having a size equal to or larger than said size defined by said slice granularity.

4. The method according to claim 1, wherein said size of said smallest possible coding unit is N×N pixels and determining said coding units comprises determining, for said at least one slice, said coding units that potentially could constitute said end of said slice to be coding units in said slice for which i) (x+1) is evenly divisible by N or (x+1) is equal to a width of said picture and ii) (y+1) is evenly divisible by N or (y+1) is equal to a height of said picture, wherein (x, y) represents coordinates of a bottom-right pixel in said coding unit in a coordinate system with at a top-left corner of said picture.

5. The method according to claim 1, further comprising generating a bitstream as encoded representation of said picture, said bitstream comprises, for each coding unit in each slice of said at least one slice, a respective coded representation of pixel values of said coding unit and, for each coding unit of said coding units that potentially could constitute said end of said slice, a respective end-of-slice flag.

6. The method according to claim 5, wherein generating said bitstream comprises associating a parameter set comprising said slice granularity to said bitstream.

7. The method according to claim 1, wherein said picture 04-comprises multiple slices and providing said slice granularity comprises providing, for said multiple slices of said picture, said slice granularity and determining said coding units comprises determining, for each slice of said multiple slices and based on coordinates of said coding units in said slice and said slice granularity, said coding units that potentially could constitute said end of said slice.

8. A method of decoding a bitstream as an encoded representation of a picture comprising at least one slice of coding units each having a respective size ranging from a size of a largest coding unit to a size of a smallest coding unit, comprising:
providing, for at least one slice of said picture, a slice granularity representing a hierarchical level for slice boundary alignment, said hierarchical level defining a size of a smallest possible coding unit at which a slice start and a slice end in said picture can be aligned;
determining, for said at least one slice and based on coordinates of said coding units in said slice and said slice granularity, coding units that potentially could constitute an end of said slice;
parsing, in said bitstream, an end-of-slice flag associated with a coding unit selected among said coding units that potentially could constitute said end of said slice; and
determining whether an end of said slice has been identified based on said end-of-slice flag.

9. The method according to claim 8, wherein determining said coding units comprises determining, for said at least one slice and based on coordinates of said coding units in said slice and said slice granularity, said coding units that potentially could constitute said end of said slice to be any coding unit in said at least one slice having a size equal to or larger than a size defined by said slice granularity.

10. The method according to claim 9, wherein determining said coding units comprises determining, for said at least one slice and based on coordinates of said coding units in said slice and said slice granularity, said coding units that potentially could constitute said end of said slice to be any coding unit in said at least one slice having a size equal to or larger than said size defined by said slice granularity and any coding unit constituting a last coding unit in a coding unit having a size equal to or larger than said size defined by said slice granularity.

11. The method according to claim 8, wherein said size of said smallest possible coding unit is N×N pixels and determining said coding units comprises determining, for said at least one slice, said coding units that potentially could constitute said end of said slice to be coding units in said slice for which i) (x₊1) is evenly divisible by N or (x+1) is equal to a width of said picture and ii) (y+1) is evenly divisible by N or (y+1) is equal to a height of said picture, wherein (x, y) represents coordinates of a bottom-right pixel in said coding unit in a coordinate system with at a top-left corner of said picture.

12. The method according to claim 8 wherein providing said slice granularity comprises retrieving, for said at least one slice of said picture, said slice granularity from a parameter set associated with said bitstream.

13. The method according to claim 8, wherein determining whether said end of said slice has been identified comprises:
determining that a current coding unit associated with said end-of-slice flag does not constitute a last coding unit of said slice if said end-of-slice flag has a first value; and
determining that said current coding unit associated with said end-of-slice flag constitutes said last coding unit of said slice if said end-of-slice flag has a second, different value.

14. An encoder configured to encode a picture comprising at least one slice of coding units each having a respective size ranging from a size of a largest coding unit to a size of a smallest coding unit, said encoder comprising:
a slice granularity provider configured to provide, for at least one slice of said picture, a slice granularity representing a hierarchical level for slice boundary alignment, said hierarchical level defining a size of a smallest possible coding unit at which a slice start and a slice end in said picture can be aligned;
a coding unit determiner configured to determine, for said at least one slice and based on coordinates of said coding units in said slice and said slice granularity, coding units that potentially could constitute an end of said slice; and
a flag assigner configured to i) assign, to each coding unit that potentially could constitute said end of said slice except one coding unit, an end-of-slice flag having a first value and ii) assign, to said one coding unit, an end-of-slice flag having a second, different value.

15. The encoder according to claim 14, wherein said coding unit determiner is configured to determine, for said at least one slice and based on coordinates of said coding units in said slice and said slice granularity, said coding units that potentially could constitute said end of said slice to be any coding unit in said at least one slice having a size equal to or larger than a size defined by said slice granularity.

16. The encoder according to claim 15, wherein said coding unit determiner is configured to determine, for said at least one slice and based on coordinates of said coding units in said slice and said slice granularity, said coding units that potentially could constitute said end of said slice to be any coding unit in said at least one slice having a size equal to or larger than said size defined by said slice granularity and any coding unit constituting a last coding unit in a coding unit having a size equal to or larger than said size defined by said slice granularity.

17. The encoder according to claim 14, wherein said size of said smallest possible coding unit is N×N pixels and said coding unit determiner is configured to determine, for said at least one slice, said coding units that potentially could constitute said end of said slice to be coding units in said slice for which i) (x+1) is evenly divisible by N or (x+1) is equal to a width of said picture and ii) (y+1) is evenly divisible by N or (y+1) is equal to a height of said picture, wherein (x, y) represents coordinates of a bottom-right pixel in said coding unit in a coordinate system with at a top-left corner of said picture.

18. The encoder according to claim 14, wherein said encoder is configured to generate a bitstream as encoded representation of said picture, said bitstream comprises, for each coding unit in each slice of said at least one slice, a respective coded representation of pixel values of said coding unit and, for each coding unit of said coding units that potentially could constitute said end of said slice, a respective end-of-slice flag.

19. The encoder according to claim 18, wherein said encoder is configured to associate a parameter set comprising said slice granularity to said bitstream.

20. The encoder according to claim 14, wherein said picture comprises multiple slices and said slice granularity provider is configured to provide, for said multiple slices of said picture, said slice granularity and said coding unit determiner is configured to determine, for each slice of said multiple slices and based on coordinates of said coding units in said slice and said slice granularity, said coding units that potentially could constitute said end of said slice.

21. A decoder configured to decode a bitstream as an encoded representation of a picture comprising at least one slice of coding units each having a respective size ranging from a size of a largest coding unit to a size of a smallest coding unit, said decoder comprising:
a slice granularity provider configured to provide, for at least one slice of said picture, a slice granularity representing a hierarchical level for slice boundary alignment, said hierarchical level defining a size of a smallest possible coding unit at which a slice start and a slice end in said picture can be aligned;
a coding unit determiner configured to determine, for said at least one slice and based on coordinates of said coding units in said slice and said slice granularity, coding units that potentially could constitute an end of said slice;
a bitstream parser configured to parse, in said bitstream, an end-of-slice flag associated with a coding unit selected among said coding units, that potentially could constitute said end of said slice; and
a slice end determiner configured to determine whether an end of said slice has been identified based on said end-of-slice flag.

22. The decoder according to claim 21, wherein said coding unit determiner is configured to determine, for said at least one slice and based on coordinates of said coding units in said slice and said slice granularity, said coding units that potentially could constitute said end of said slice to be any coding unit in said at least one slice having a size equal to or larger than a size defined by said slice granularity.

23. The decoder according to claim 22, wherein said coding unit determiner is configured to determine, for said at least one slice and based on coordinates of said coding units in said slice and said slice granularity, said coding units that potentially could constitute said end of said slice to be any coding unit in said at least one slice having a size equal to or larger than said size defined by said slice granularity and any coding unit constituting a last coding unit in a coding unit having a size equal to or larger than said size defined by said slice granularity.

24. The decoder according to claim 21, wherein said size of said smallest possible coding unit is N×N pixels and said coding unit determiner is configured to determine, for said at least one slice, said coding units that potentially could constitute said end of said slice to be coding units in said slice for which i) (x+1) is evenly divisible by N or (x+1) is equal to a width of said picture and ii) (y+1) is evenly divisible by N or (y+1) is equal to a height of said picture, wherein (x, y) represents coordinates of a bottom-right pixel in said coding unit in a coordinate system with at a top-left corner of said picture.

25. The decoder according to claim 21, wherein said slice granularity provider is configured to retrieve, for said at least one slice of said picture, said slice granularity from a parameter set associated with said bitstream.

26. The decoder according to claim 21, wherein said slice end determiner is configured to i) determine that a current coding unit associated with said end-of-slice flag does not constitute a last coding unit of said slice if said end-of-slice flag has a first value, and ii) determine that said current coding unit associated with said end-of-slice flag constitutes said last coding unit of said slice if said end-of-slice flag has a second, different value.

27. A media terminal comprising:
a memory configured to store an encoded representation of a picture comprising at least one slice of coding units each having a respective size ranging from a largest coding unit to a smallest coding unit; and
a decoder configured to decode said encoded representation according to claim 21.
